(19) United States
(12) Patent Application Publication
(10) Pub. No.: US 2026/0278686 A1
(43) Pub. Date: Sep. 17, 2026

(54) MULTI-SHARE OF UNIQUE NON-FUNGIBLE TOKENS WITH PRIVACY-PRESERVING TRACKING

(71) Applicant: BIGtoken, Inc., Fairfield, CT (US)

(72) Inventors: George STELLA, Cold Spring Harbor, NY (US); Andreas FREUND, San Diego, CA (US); Richard TAUB, Fairfield, CT (US)

(21) Appl. No.: 19/300,349

(22) Filed: Aug. 14, 2025

Related U.S. Application Data
(60) Provisional application No. 63/683,069, filed on Aug. 14, 2024.

(51) Int. Cl. G06Q 40/04

(52) U.S. Cl. CPC G06Q 40/055; G06Q 2220/00

(57) ABSTRACT

Consumer and/or channel partner behavior regarding tokenized brand rewards is managed, traced, and analyzed by observing and/or controlling token exchanges. Tokenized rewards have unique identifiers and are associated with terms and/or conditions for the exchange and/or use of the tokens. This can include terms and conditions for the minting of new tokenized rewards for other users by a registered holder of a token.

### CROSS REFERENCE TO RELATED APPLICATIONS

This application is a Nonprovisional Application under 35 USC 111(a) which claims the benefit of U.S. Provisional Application No. 63/683,069, filed on Aug. 14, 2024, which is incorporated herein by reference in its entirety.

### TECHNICAL FIELD

This application pertains to the creation, distribution, gifting, trading, exchange, fulfillment, tracking, and tracing of tokenized brand rewards.

### BACKGROUND

There are many conventional ways to present consumers with brand reward offers. For example, traditional published paper coupons are printed in bulk. Consumers can clip them out of newspapers or brochures. Consumers can receive coupons in the mail or with the packaging of other products. Each such coupon typically bears a bar code to identify a discount redeemable at the point of the redemption. Typically, each coupon of a type bears the same bar code.

Printed coupons can be generated at a point of sale, e.g., based on current purchases and/or records associated with a customer loyalty card. In the digital age, consumers can also get digital coupons for themselves via web sites or apps. Various digital coupons can be printed, electronic, and/or contain promotional codes that facilitate redemption.

Many brands offer coupons to consumers who have registered with the brand by providing personally identifiable information such as names, cell phone numbers, email addresses, and the like. Digital coupons, often in the form of QR codes, often can be used a number of times. Consumers can share links to sites where digital coupons are available for download.

### SUMMARY

This disclosure pertains to the creation, distribution, gifting, trading, exchange, fulfillment, tracking, and tracing of tokenized brand rewards. Token are used, e.g., in combination with a blockchain, to help manage consumer experiences and to monitor consumer and distribution channel behaviors and interactions, and to collect data on consumer interactions with a brand, e.g., to further understanding of consumers and channel partners towards improving product and reward offers, channel efficacy, and consumer loyalty.

Digital reward tokens that are each unique and redeemable by a single consumer are minted to correspond to certain digitized terms and conditions, wherein the first set of reward tokens are initially unregistered. Consumers and/or channel partners can claim and register ownership of specific tokens. Registered token owners then, for instance, cash in, trade, sell, and/or gift their tokens in accordance with the terms and conditions. The terms and conditions can pertain, for example, to the minting of new tokens or access to specific consumer experiences or channel events.

### BRIEF DESCRIPTION OF THE FIGURES

FIG. 1 is a block diagram of a system for tracking brand rewards offers.

FIGS. 2-4 are a call flow diagram of a process for tracking brand rewards offers.

### DETAILED DESCRIPTION

### Introduction

### Long-Felt Needs

Brands want more information about consumer sentiments. They also want to learn about how consumers connect with the brand and with each other. Brands address this by reaching out with reward offers. But traditional ways of offering rewards fall short.

You generally cannot determine from a traditional printed coupon how it came into the hands of the consumer presenting it. Often it cannot even be determined which marketing channel distributed the coupon, much less the social and/or commercial interactions that brought the coupon to the consumer.

Similar issues can arise with digital coupons. Further, digital coupons introduce new concerns for consumer privacy, as well consumer frustration with traditional online on-boarding processes, too many passwords, too much spam or other unwanted marketing, or other excessive navigation on digital devices. Brands need new ways to collect relevant information without putting consumers' personally identifiable information at risk.

Herein the term “brands” refers generally to parties wishing to advertise products (goods and/or services) that are available to buyers and/or consumers. Brands can be manufacturers, distributors, retail stores, online merchandisers, medical services providers, financial services, and the like, but can also be charities, faith-based organizations, political organizations, for example. Brands are people or groups of people with a message about something of value.

Consumer experiences with brands can include virtual engagement via electronic media and/or live experiences leading to digital connections. For example, consumers can engage with brands on social media by liking and/or viewing posts, following, accounts, and/or mentioning, tagging, or hash tagging products. Similarly consumers can interact with brands via online product browsing, shopping, purchasing, and/or reviewing products or making product inquiries.

An experience can have many facets that designed by the brand. This includes when and where a consumer encounters the brand, media presented to the consumer on the occasion of the encounter, and offers made to consumer. The design of the experience can further include specific pathways for the consumer to engage in more experiences with the brand, and pathways to claim an offer, redeem an offer, gift an offer, share an offer, and/or trade an offer with other consumers.

Consumer experiences with brands can occur live, e.g., while shopping, in public, or at an event. For example, a consumer can learn about a brand at a concert or sporting event, and then engage with the brand online. For example, consumers can search for a brand name online and/or follow a quick-response (QR) bar code to a brand website or other brand location. Consumers can further share brand information with friends, e.g., via social media or messaging.

### Tokenization for Secure Collection of Comprehensive Data

This disclosure describes techniques for multi-sharing of unique digital Non-Fungible Tokens (NFTs) for rewards and experiences offered by brands. Brands can mint tokens that have varying terms and conditions. Brands can facilitate the sharing, transferring, and redeeming of tokens via applications and functions of a computerized multi-share brand rewards system. The use of tokens allows unique tracking of each token.

End-consumer privacy can be preserved in the system by using pseudonymous token technology in the brand rewards system without requiring or preserving any personally identifiable information (PII). Consumers and brands can then communicate rapidly without any divulging of consumer PII.

### Unique Tokenization for Consumer Behavior Analysis

Using reward tokens generated for a consumer experience, a brand can track behavior of individual consumers and/or interactions among consumers, as well as update profile data about them and act upon the data, in near real-time, e.g., as transactions are posted to a blockchain. This allows live and almost-live pseudonymous analysis of consumer behavior. The consumer behavior can thus be tracked through multiple experiences without knowing the identity of the consumer.

Further, by permitting multiple consumers to share tokens with each other via a brand rewards system, the behavior of multiple consumers and networks of consumers can be analyzed without breaching consumer privacy.

Token and blockchain operations can be implemented using conventional blockchain technologies. The brand rewards system can be implemented using conventional digital computer server systems. Additional or alternatively, the functions of the brand rewards system can be implemented on a stateful, quasi-Turing-complete blockchain.

Tokens can be exchanged in a variety of ways. For example, a brand generates tokens for a reward to be offered to consumers. The brand creates a consumer experience including media, sharing, and/or live events by which the consumer learns about the offer. A first consumer, user A, then contacts the brand or a partner of the brand to claim the offer. A unique token is then registered to user A under the rubric of a digital address for user A. User A then shares the token with user B, giving user B the option of claiming the token for user B. User B accepts and claims the token. The system registers the token to user B under the rubric of a digital address for user B. User B then redeems the token to obtain the reward, and the system destroys the token, also known as burning the token, to take it out of circulation. Alternatively, a token can be burned as use by a specific user, while still allowing that user to share the link to the token for use by another user. In either case, the use of the token is tracked per user.

Similarly, a brand can generate tokens to track experiences, whereby access to, e.g., media files or key information, is controlled by possession of token. Such experience tokens can be exchanged and tracked in the manner of consumer reward tokens.

### System Overview

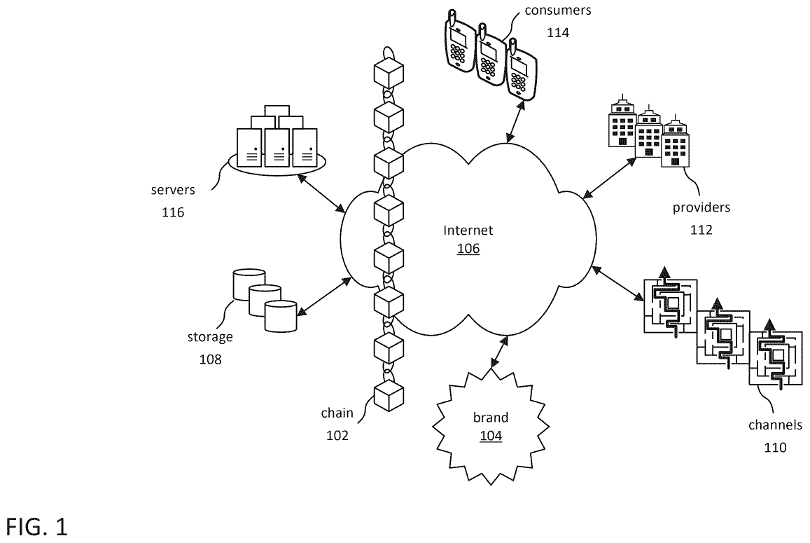

FIG. 1 is a block diagram of an example system for managing brand reward offers via tokenization. A product brand 104, value communication channels 110, product providers 112, goods and services consumers 114, computer servers 116, data and function storage facilities 108, and a blockchain 102 are able to communicate via the Internet 106.

In FIG. 1, blockchain 102 is depicted as a public blockchain on the internet. Additionally or alternatively, in practice a private blockchain may be used, e.g., via servers managed by the brand. Similarly, non-blockchain tokenization mechanisms may be used to achieve many of the benefits of the techniques described herein.

Product brands benefit from knowledge of how their product offerings are perceived by consumers. Unique tokenization of reward offers such as product discounts allows tracking of the exact acquisition, exchange, and use such offers. Blockchain technologies provide a convenient way to do so while protecting consumer privacy and improving user experiences by eliminating, e.g., creating and maintaining accounts on consumer devices. Unique tokenization provides ways to track consumer-to-consumer interactions in the acquisition and exchange of

Similarly, unique tokenization provides opportunities for close tracking of the provenance of the offers and experiences designed by the brand as these pass through myriad marketing, advertising, and commercial channel partners. Via tokenization, brands can permit and/or observe the transfer and/or exchange of offers and experiences provided to one or more channels.

In FIG. 1, the brand 104 can design a consumer experience which includes an opportunity for consumers to acquire product rewards. To do so the brand 104 stores information regarding the experience and the offer in one or more storage facilities 108, with the data accessible via one or more servers 116. The data can be tokenized, e.g., to track how and when the data is being accessed by channels 110, providers 112, and consumers 114. The blockchain 102 provides the tracking of transactions of tokenized items.

In practice, the distinctions between consumers and channel partners can be unclear, where intermediaries such as influencers can act both as individual consumers of a brand and as a volunteer or paid commercial partner of the brand and/or a channel partner of a brand. Token terms and conditions can be devised to accommodate a wide variety of practices, such as rewards unlocked for consumers stepping up to influencer roles and/or special opportunities for established influencers. The same applies to other spreaders and marketers of brand offers.

For example, the brand 104 can design an experience of a product introduction at a concert held by a provider 112 and promoted via an advertising channel 110. The experience can include various media elements placed in storage 108 by the brand and retrieved by the channel 110 and the provider 112 via a server 116 using an experience token. The server 116 can interact with the blockchain 102, e.g., to verify that such access is proper and/or record the transaction.

At the concert, the provider 112 can play the experience media thus acquired. Consumer attendees of the concert 114 as well as those with whom these consumers have shared the token can learn of an offer from the brand 104 via the playing of the experience media, and choose to use a link, QR code, keyword, or the like to find a server 116 which allows them to claim and offer for immediate or future use. The server 116 provides them with a unique token for their claimed offer.

Later, the consumer 114 can present the token to another provider 112, e.g., a retailer, to cash in the reward. The retailer 112 can contact a server 116 to verify the transaction, and the server 116 can see to the recording of the transaction on the blockchain.

### Data and Functions

The system can store various records of the experiences, offers, and transactions, and define various events and functions for their management. Of course, there are innumerable ways to structure computer data and functionality, including storage and operations on the blockchain and off-blockchain. The following are offered by way of illustration.

Digital wallets can be used by end-user consumers and marketers to generate valid transactions by appending a cryptographic digital signature to a blockchain transaction, where the signature is generated by the cryptographic key that controls the blockchain account from which the transaction is sent. Wallets to generate cryptographic digital signatures can be hosted on behalf of a user by a third party. Similarly, the user can host their own wallet independently.

Data regarding token status and transactions can be maintained on the blockchain 102, servers 116, and/or storage 108. Records can be kept per token, experience, offer, user, channel, and/or provider. For example, in addition to tracking which tokens are registered to a party, the system can track the terms and conditions for each token, who shared and who received shared tokens, conditions applied to sharing the token. The system can record current balances and transaction histories of tokens.

Computing function can similarly be distributed in the blockchain 102 as smart contracts and/or in servers. Functions can include notification events, for instance, such as the blockchain events when a token is claimed, registered, shared, canceled, and/or becomes expired. Functions can be provided to return information such as the number of tokens an address is currently sharing, deadlines to claim shared tokens. Functions can be provided to mint, claim, register, share, cancel a share, transfer, and/or burn a token. Functions can include testing conditions set at minting and/or set by parties sharing the token.

The system can include administration functions, e.g., to be used by the brand to secure and maintain accounts and records for users and other parties.

### Example Blockchain Implementation

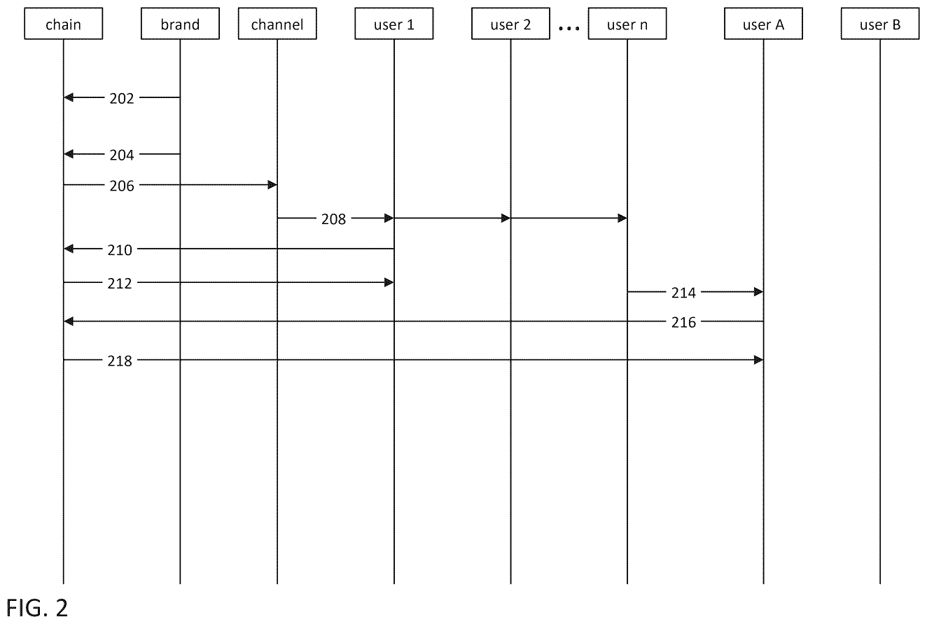

FIG. 2 illustrates a variety of techniques that can be exploited together or separately in various combinations to track and analyzing information regarding consumer experiences and conduct. In this example, a brand exploit blockchain technology for distributing, tracking, and collecting information regarding the creation, implementation, and use of consumer experiences and offers. Here a brand uses a channel to reach consumer users, initially without knowing who those users can be.

In processes like that of FIG. 2, experiences, offers, and/or users can be tracked with unique tokens. That is, there can be separate tokens for each channel, experience, offer, and/or each user. Additionally or alternatively, channels, experience, and users can be identified by addresses.

For illustrative purposes, FIG. 2 will be described in terms of a brand launch at a concert and ensuing consumer behavior and brand responses to that behavior. In this example, the blockchain is a conventional public blockchain, the brand is a consumer product company, the channel is the concert promoter or venue. User 1 through user n are concert attendees. Users A and B are people who did not attend the concert experience, but learn about brand offers from those who did.

At step 202, the brand posts information about a consumer experience to a blockchain. This information can include links to data that is useful either to the channel or consumer, and/or information used internally by the brand for tracking the experience. Additionally or alternatively, the brand can such information directly to a channel who will later distribute the experience.

For example, the brand can design an experience for attendees of a concert. The information placed on the blockchain can then include links to audio and/or video to presented to consumers at the concert, links where users can claim offers, and/or more information about the brand, offers, products, and/or ways to share offer tokens with friends.

At step 204 of FIG. 1, the brand sends a transaction to the blockchain which results in the minting one or more unique tokens that can be claimed by users through the experience and/or shared. For example, the brand can design the experience to include limited number of tokens for a special offer. Additionally or alternatively, minting can be deferred until a user interacts with the blockchain in response to an experience.

At 206, the blockchain emits relevant the experience information to the channel. Additionally or alternatively, the brand can send such information directly to the channel and/or directly to consumers. Events from the blockchain can be controlled by conventional blockchain contract or other mechanisms. This permits central secure tracking of communications between the brand and the channel about details of the experience. For example, the media content and offer details can be changed dynamically by brand posting to the blockchain, e.g., in response to live events.

At 208, the channel shares the experience with first group of users include user 1 through user n, e.g., when they attend the concert.

At 210, user 1 requests a token based on the experience by following guidance in the experience for claiming an offer. For example, user 1 can use a link of a QR code shown at the concert to receive a coupon or discount. The link sends a transaction to the blockchain, without requiring user 1 to sign up.

At 212, the blockchain emits a notice to user 1 that a unique token X has been claimed by user 1. Token X is a means to redeem an offer from the brand. The address of user 1 is now registered. A blockchain record now exists of token X being associated with the address of user 1.

In contrast, rather than claiming an offer at the concert experience, at 214 user n forwards information about the experience to user A. User A did not attend the experience, but receives enough information from user n to know where to request a token for the reward offered through the experience.

In practice, the system may further respond to such actions in a number of ways that are not illustrated in the figures. For example, a concert attendee who shares a token with others may be rewarded, e.g., through additional tokens, based on the number of people with whom the original token is shared and/or the recipients of the shared token who register as users or redeem the shared token.

At 216, based on the information from message 214, user A requests a token for herself.

At 218, the blockchain emits a notice to user A that a unique token Y has been granted to her. User A is now registered. User A's possession of token Y is now recorded on the blockchain.

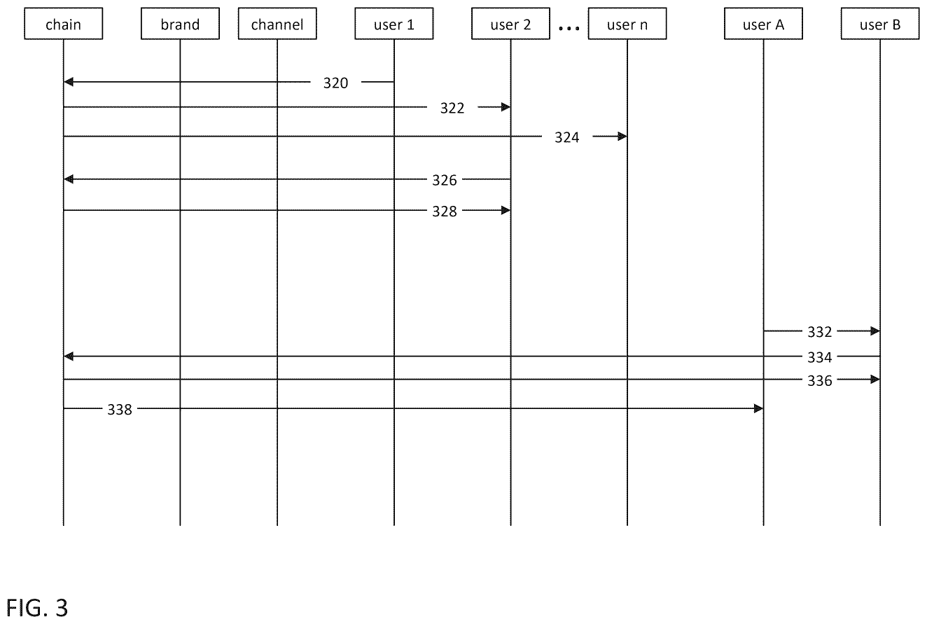

The call flow of FIG. 2 is continued in FIG. 3. At step 320 of FIG. 3, user 1 offers to share their token X with user 2 or user n. User 1 does so by providing information to the blockchain such as addresses for user 2 and user n. The information can further include any terms and conditions that user 1 wishes to be applied for sharing their token. For example, the token can be shared for free or compensation, and the offer to share can have an expiration.

At 322 and 324, the blockchain emits to user 2 and user n, respectively. information about the offer from user 1 to share their token with them.

At 326, user 2 posts to the blockchain to claim token X in accordance with the offer to share by token X. The blockchain processes claim 326 by checking it against rules designed by the brand for the token. The blockchain can further process claim 326 for conformance with conditions added and/or set by user 1 at step 320. At 328, the blockchain emits a confirmation that user 2 has successfully claimed token X.

Separately, at 332, user A privately offers their token Y to user B. User A does this directly without contacting the blockchain. For example, user B may be a friend of user A. User A can send the offer information to user B via private messaging.

At 334, user B requests that the token of user A be transferred to user B by sending a transaction to the blockchain. At 336, after checking applicable conditions, the blockchain emits a response to user B confirming that user B she has successfully claimed token Y. At 338, the blockchain emits a notification to user A that user B has claimed token Y.

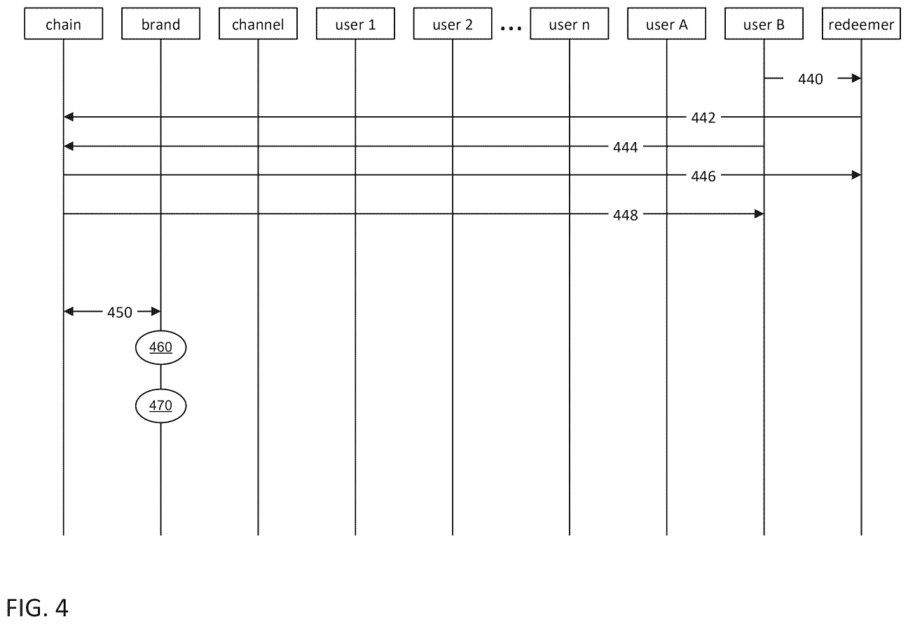

The call flow of FIGS. 2 and 3 is continued in FIG. 4. FIG. 4 adds a redeemer, i.e., a brand rewards redemption partner. The redeemer may be a retailer who will sell a brand product at a discount with the presentation of a valid token. Alternatively, the redeemer may be a channel for a new consumer experience sponsored by the brand, for example.

At step 440 of FIG. 4, user B requests redemption of the brand reward the brand has associated with token Y. As with all signaling in the examples of FIGS. 2-4, the signaling of the intent to redeem the offer, validation of the token, and confirmation of redemption can occur in a variety ways. For example, at 440 user B can present a paper or digital QR code to the redeemer. The redeemer can then present the information provided by user B to the blockchain at 442, and at 446 subsequently receive confirmation that proper conditions are met for redemption. Additionally or alternatively, at 444 user B can post a redemption request to the blockchain, and user B can receive a confirmation of the redemption at 448.

Through tracking user-specific instances of reward offers, brands can gather deep insights into consumer behavior, preferences, and networks. Such tracking may be essentially anonymous, e.g., via pseudonymous blockchain tracking.

For example, at steps 210 and 216 of FIG. 2, the system acquired information about user 1 and user A being interested in the offer at the experience defined at step 202. Depending on the specifics of signaling, e.g., which URLs are involved in transferring information about the offer at the experience, the system can infer which users attended the experience versus which users heard about it second-hand.

At step 320 of FIG. 3, the system learned that user 1 is connected to user 2 and user n, and further learned that user 1 was less interested in having the offer for themselves versus sharing it with others. At step 326, the system learned that user 2 was interested in the offer. Here, with token X, the full provenance of token is known. This includes in which experience the token originated, in which channel it was experienced, and which user held it at any time.

Through study of many such tracked offers and associated tokens, inferences may be drawn about patterns of influence in social networks. This includes of learning the levels of influence among users in a network, allowing the identification of influencer to be used, in effect, as new channels.

This is true even when initial data is incomplete. For example, signaling such as message 214 of FIG. 2 can be off a blockchain. Alternatively, a link in message 214 may be engineered to capture at least address information about user n. Nonetheless, at a minimum information is known to the system about user A's interest in and acceptance of token Y.

Then in the sharing process of steps 332 through 338 of FIG. 3, the system has learned of the relationship between user A and user B. In the redemption process of steps 332 to 342 of FIG. 3, the system learns which redemption outlet is preferred by user B, and that user B finds the offer worth redeeming.

With all this token transaction information captured on the blockchain, and/or at sites used to conduct the transactions, the brand may then perform desired consumer behavior, network, and preference analysis. For example, at step 450 the brand can acquire records of all transactions pertinent to, e.g., the brand, an experience, an offer, a user, and/or combinations and groups thereof.

### Variations

Transaction data and other records may be stored on a blockchain, off blockchain, on both, or in a mixture of on and off blockchain. Similarly, through the use of smart contracts and similar technology, data processing functionality of the system may be implemented on blockchain or partially on a blockchain.

Tokenization may be achieved on or off blockchain as well. However, blockchain operations may provide easier security of token uniqueness and consumer privacy.

A blockchain implementation can use mappings to keep track of token-related data. For example, a deposits mapping can track whether a token is currently being shared. A senders mapping can track of who shared which token. A deadlines mapping can track deadlines for sharing a token. A shared balance mapping can track of how many tokens the user is currently sharing. In the system, each end consumer can be tracked as an address.

In practice, for example, the deposits mapping can map a token identifier to a Boolean value indicating whether the token is currently being shared. The senders mapping can map a token identifier to the address of the account that shared the token. The deadlines mapping can map a token identifier to the deadline for sharing the token. The shared balance mapping can map an address to the number and/or IDs of tokens it is currently sharing.

A brand rewards system implemented on a blockchain can define several system events for communicating information regarding changes in the state of token-related data. For example, events can include events such as: token share registered; token claimed; and token share cancelled. For a system implemented on a blockchain, these events can be emitted when a token is shared, claimed, or the share is canceled, respectively.

The brand rewards system can provide several public functions for executing and recording token transaction. Such functions can be implemented via blockchain contracts, conventional software, or combinations thereof.

For example, a mint reward token function can be used to create new tokens. A transfer reward token function can be used to transfer of tokens from one consumer/address to another. A burn reward token function can be used for the destruction of tokens.

Functions can be configured to operate in accordance with various business rules. For example, it can be preferred that the transfer reward token function and/or the burn reward token can only be used on a token that is not currently being shared.

A share token function can be used to permit a token owner to share their token with a target consumer/address, e.g., until a specified deadline. A claim token function can be used by the target address to be claim the shared token. A cancel share function can be used by the token owner to cancel the share before the shared token has been claimed.

The system can further include private functions which are not publicly accessible by consumers. For example, clear share information function can be used by an administrator to clear the sharing information of a token, e.g., when the token is claimed or when the share is canceled.

### Example Workflows

### Minting a New Reward Token

Tokens can be minted ahead of time, as a result of a past action or on demand. For example, a user discovers a brand reward experience, e.g., while shopping in person, browsing online, or messaged by a friend. The user is directed to claim a reward token using an online brand rewards system application. The application may be downloadable, at a web site, or a Progressive Web App (PWA), for example.

Using the online application, the user accepts the reward. The backend of the brand rewards system receives the claim request, validates the request, and calls a mint reward token function. Validation can include checking terms and conditions of the experience, e.g., as to expiration of the experience, eligibility of the user, status of the user (if known), address proffered by the user, etc.

All of the functions described herein, including the mint reward token function, can include updating blockchain records. Functions can be achieved using blockchain contracts and/or via convention software methods.

Minting may occur outside of the brand rewards system, e.g., on a public blockchain. After calling the mint reward toking function, the backend listens for a transaction confirmation, updates the database with the new token information, and associates the new token with the reward experience data and address of the user.

When backend operations are complete, the user sees their new reward token on their device. User notifications may follow different pathways, and the user may receive more than one notification. For example, notifications can come to the user from a brand rewards system application and/or from a blockchain event triggered by the associated transaction.

### Transferring a Token

Users can transfer their tokens to other users. For example, a user navigates to a transfer token page in brand rewards system application. The user enters or otherwise indicates the recipient's address and token identifier and submits the request. The backend receives the transfer request, validates the data, and calls a transfer reward token function in the contract. The backend listens for the transaction confirmation, updates the database with the new token owner information and notifies the user.

### Redeeming a Reward Token

It is often advantageous to use single-use tokens, whereby redeemed tokens are destroyed rather than returned to a pool of available tokens. For example, a user navigates to a redeem token page in a brand rewards system application. The user selects the token to be redeemed and submits the request. The backend receives the redeem token request, validates the data, and calls a burn reward token function. The backend listens for the transaction confirmation and notifies the user. The backend further removes the token from any database of active tokens. The token cannot thereafter be claimed, redeemed, or otherwise used.

However, records of transactions involving the token will be preserved on any blockchain where they appear. Additionally or alternatively, the system can preserve transaction, history, ownership, use, timing, provenance, and similar data that provides a view of the origin, exchange, and use of the token. Such data reflects consumer tastes and interconnectedness.

Sharing a Token without Specifying a Receiver

Users can offer their tokens to others via sharing. Here, rather than transferring a token outright, a user shares an opportunity with another user whereby the other user can claim the token for themselves. The other user can accept, decline, or ignore the share offer.

For example, a user navigates to the share token page of a brand rewards system application. The user selects a type of token and a number of tokens to be shared. The user can add conditions, such as a deadline by which the offer must be accepted. Then the user submits the request.

The backend receives the share token request, validates the data, and calls a share token function. The backend listens for a token share registered event and updates the database with the token-sharing information. The backend generates a URL and custom sharing message, where the URL points to a backend API of a claim shared token function.

The user deploys the sharing URL in a message on the digital communication and engagement application of their choice, e.g., SMS, email, testing apps, social media apps, etc.

### Claiming a Shared Token

Receivers of the message can then go to the API to claim one of the shared tokens. The receiver clicks on the sharing URL and is navigated to the claim token page of a brand rewards system application. The receiver user claims the shared token.

The backend receives the claim token request, validates the data, and calls a claim token. The backend listens for a token claimed event, updates the database with the new token owner information, and notifies the receiver claiming the token and/or the user who shared the token.

If the receiver was not already known to brand rewards system, the receiver has now become a user.

### User-to-User Token Sharing and Claiming

The holder of a token can specify people to who the holder wishes to share the token. For example, user A navigates to the share token page the brand rewards system application. User A selects the token type, the number of tokens to be shared, and a deadline or other requirements, if any. User A then submits the request.

The backend receives the share token request, validates the data, and calls the share token function.

The backend listens for a token share registered event, updates the database with the token-sharing information, and generates a URL and custom sharing message. The URL points to the backend API of the claim shared token function. user A deploys the sharing URL and text on the digital communication and engagement application of their choice (e.g., SMS, Email, Testing Apps, Social Media Apps, etc.)

A user B receives or views the sharing message and clicks on the sharing URL in the application the URL is discovered. User B is directed to a webpage to either accept or refuse the share. If the share is accepted, User B is directed to a page of the brand rewards system. The page can be a login screen, for example, where if user B successfully logs in, user B automatically claims the shared token and is directed to the graphical visualization of the token's held by user B.

When the token is claimed by user B, the backend receives a claim token request, validates the data, and calls the claim token function.

The backend listens for the token claimed event, updates the database with the new token owner information, and notifies user A of the transfer.

Many variations are possible. For example, user A can stipulate to whom the share is to be offered. To do so, user A can indicate one or more individuals by their addresses, or indicate a group of individuals known to the system. The offerees are included in the request, and the system emits the notification of the offer to the offerees, rather than providing a URL that user A can send to the offerees. The offerees can follow a link in the notification to claim the reward token.

### Cancelling a Share

To cancel a share, for example, a user navigates to a cancel share page of a brand rewards system application. The user selects the tokens to un-share and submits the request. The backend receives the cancel share request, validates the data, and calls a cancel share function in the contract. The backend listens for a token share cancelled event, updates the database to remove the token-sharing information, and notifies the user.

### Viewing Shared Balance and Sharing Deadlines

Functions can be provided for users to see information about their reward tokens. For example, a user wishing to see the status of tokens she has shared can navigates to a shared balance page of a brand rewards system application and requests updated balances. The backend retrieves the shared balance from the database and sends it to the user's device. Similarly, the system can include a page where the user may obtain information about deadlines and/or other terms or conditions of shares.

### Consumer Sentiment Analysis

The brand collects information on end-consumer interactions with the brand, experiences, and each other via records of user interactions with reward tokens. The deployment, exchange, and redemption of tokens may be achieved off blockchain, on blockchain, or through a mixture of on blockchain and off blockchain technology. For example, the minting, sharing, transfer, redemption, and burning of tokens may be managed through one or more blockchain contracts, e.g., including notifications provide by blockchain events.

The brand performs analysis of end-consumer interactions augmented by relevant data such as time, date, location, reward type, design, messaging of the consumer experience, etc., to understand the type of behavior. The analysis can include patterns and parties to claim, sharing, and redemption of tokens.

From the analysis, the brand can develop a detailed end-consumer behavioral profile for each user and for groups of users. Further, the brand can make inferences about channels and provider using data of the circumstances in which the reward experiences are encountered. The end-consumer behavior/sentiment analysis can be conducted across multiple reward tokens without using any Personal Identifiable Information (PII) of any user through the use of pseudonymous address information for each user together with contextual brand reward token data.

### Brand End Consumer Microtargeting

Using each user's profile, the brand can deploy new, targeted reward token. For example, the brand can mint new reward tokens on a blockchain with rewards offers that are tailored according to user profiles.

For each offer, the backend listens for a confirmation of a claiming transaction, updates the database with the new token information, and associates the new token with the reward experience data. The user can see the new reward token in an existing or a new reward experience context within the brand rewards system framework.

### Channel Workflows

A brand rewards system can include applications providing services to channel partners and providers that are analogous to those offered to product consumer and buyers. Workflows for channel partners can be directed to the management of experience tokens. Experience tokens can be minted for consumer experiences that are planned by the brand. The experience tokens can be minted on demand or in advance of the planned experience, and used to track which specific channels and providers are involved in the experience, and how each channel and provider partner participates in the experience and in the lifecycle of reward tokens.

The experience tokens can be claimed, transferred, shared, and redeemed via workflows that are similar to those used for reward tokens. Experience tokens can be used to control which applications can be used by which partner and/or which reward tokens are provided to consumers reached through the partner. This control of reward tokens through the use of experience tokens permits control of which applications, benefits, etc., are available to consumers reached through a specific partner. Similarly, experience tokens can be used to gate access to experience events, media files and other experiences.

For example, a brand plans a reward experience for an upcoming concert tour. The experience involves the launch of a new consumer product, and the rewards offer is exclusive early access the new consumer product. Presentation of the experience includes the release of a new music video.

The brand offers separate experience tokens to providers to host the concert, channels to promote the product and the concert, and channels to provide fulfillment in the delivery the new product.

A small concert venue claims a token to host the concert and is refused, e.g., for insufficient seating capacity. The token is not registered to the small venue. A larger venue claims and is granted a first concert experience token. An even bigger venue claims the offer and is granted a second concert experience token valid for another day on the concert tour.

An advertising channel claims and is granted a national ad campaign experience token. A national retail blockchain claims and is granted an exclusive fulfillment experience token.

In the days leading up to the concerts, the advertising channel uses its token to unlock and/or decrypt press releases and other media controlled by the brand. During the concerts, the venues use their tokens to unlock/decrypt the new video. After the show, the retailer uses its token to enable redemption of consumer reward tokens via its cash register system.

The partners can use a token exchange to manage their business network. For example, the venues can provide their tokens to their concert live video vendor, without releasing the media content itself. The transfers to the subcontractors are tracked by the brand. Similarly, the advertiser can share their token with local television and radio affiliates, without knowing which will claim it. The retailer can share their token with a variety of retail chains within their brand family, without knowing which will claim it.

This provides the brand with granular information about the business networks involved in their consumer facing supply blockchain, enabling analysis of channel partner sentiments and interconnectedness. Combining information from experience tokens and reward tokens, brands can assess the efficacy of individual channel partners in reaching consumers, e.g., by minting reward tokens connected with experience tokens and/or observing which experience token is affiliated with a transaction involved a reward token. For example, different app pages may be linked to different experience tokens.

This has implications for both large and small experiences. Large experiences, e.g., product releases occurring during a national concert tour, can normally fund staff to manage the coordination of the release of rewards offers. But manual labor is time consuming and prone to leakage of confidential business information. And tokenization can provide information about partner and subcontractor activity which cannot be tracked manually.

Further, the use of experience tokens allows management of smaller experiences in consistent, secure, and data rich ways. For example, consumers identified as influencers via analysis of reward token provenance records can be converted to channel partners using experience tokens to gate the access of the influencer to brand media and brand applications, as well as to track the influencers performance as a channel partner.

We claim:

1. A computer implemented method for monitoring consumer behavior regarding brand rewards offers, the method using digital reward tokens that are each unique and redeemable by a single consumer, the method comprising:
minting, on a blockchain, a first set of reward tokens that are subject to a first set of digitized terms and conditions, wherein the first set of reward tokens are initially unregistered;
presenting, to a first set of consumers, a first offer of the first set of reward tokens;
registering on the blockchain a unique token to each of one or more consumers claiming the first offer, the separate unique tokens being selected from the first set of tokens, wherein each registration comprises an association of an identifier of the unique token with a pseudonymous address of the respective claiming consumer;
sharing, to a second user at the request of a first user, a second offer pertaining to a first registered token, the first registered token being currently registered to the first user;
in response to the second user claiming the second offer, transferring the first registered token on the blockchain, whereby by a new token registration is created comprising the identifier of the first registered token and a pseudonymous address of the second user.
